(19) United States
(12) Patent Application Publication
(10) Pub. No.: US 2019/0016924 A1
(43) Pub. Date: Jan. 17, 2019

(54) BIODEGRADABLE FILM HAVING AN ADHESIVE AND METHODS OF USE THEREOF

(71) Applicants: Frank Albert CINI, Toronto (CA); Norman WRIGHT, Toronto (CA)

(72) Inventors: Frank Albert CINI, Toronto (CA); Norman WRIGHT, Toronto (CA)

(21) Appl. No.: 15/522,689

(22) PCT Filed: Oct. 27, 2015
(86) PCT No.: PCT/CA2015/000555

§ 371 Date: Apr. 27, 2017

Related U.S. Application Data
(60) Provisional application No. 62/069,107, filed on Oct. 27, 2014.

(51) Int. Cl. C09J 7/29; C09J 7/25; C09J 7/38; C09J 201/02

(52) U.S. Cl. CPC C09J 7/29; C09J 7/255; A45D 19/0025; C09J 201/02; C09J 7/38

(57) ABSTRACT

In one aspect, there is provided a sheet comprising a biodegradable film having a first surface and an opposing second surface; and an adhesive, wherein the adhesive is applied to the first surface and wherein the sheet has a peel force of between about 0.02 pounds per inch to about 0.15 pounds per inch, preferably about 0.03 pounds per inch to about 0.1 pounds per inch, further preferably about 0.07 pounds per inch.

### TECHNICAL FIELD

This disclosure relates to compositions used in styling an individual's or animal's hair.

### BACKGROUND

Aluminum is a widely used material in the professional hairstylist industry. Hairstylist professionals may use aluminum foil as a means of separating and isolating hair during colouring, highlighting and lowlighting to differentially colour different strands and groups of strands in an individual's hair, achieving a spectrum of colours or shades in that individual's hair.

Sheets, strips and rolls of aluminum may often be the preferred material for hair stylists as it may be robust enough to withstand exposure to colour and bleaching agents, may be resistant to heat applied using a hairdryer, and yet may still be pliable enough to be manipulated, moved, shifted, bent, folded, refolded or otherwise repositioned to effectively segregate the desired segments of hair.

However, the environmental and financial cost associated with the use of aluminum may be significant. There may be environmental impacts associated with each stage of aluminum production, from extraction to processing. The major environmental impact of refining and smelting may be greenhouse gas emissions. These gases result from both the electrical consumption of smelters and the by-products of processing. The greenhouse gases resulting from primary production include perfluorocarbons (PFC), polycyclic aromatic hydrocarbon (PAH), fluoride, sulfur dioxide (S02), and carbon dioxide (CO2). Of these gases, PFCs resulting from the smelting process are the most potent. It has been observed that primary aluminum production may be a leading source of perfluorocarbon emissions in the United States. PAH emissions result from the manufacture of anodes for smelters and during the electrolytic process. Sulfur dioxide and sodium fluoride are emitted from smelters and electrical plants. SO2 is one of the primary precursors of acid rain. CO2 emissions occur during smelting and result from the consumption of carbon anodes and from PFC emissions. For each ton of aluminum produced, energy requirements may reach 170 million British thermal units of energy, with about 12 tons of carbon dioxide-equivalent also produced. In addition, the U.S.-based Environmental Protection Agency has indicated that the release of perfluorocarbons during the aluminum smelting process are 9,200 times more harmful than carbon dioxide in terms of their effect on global warming.

Compounding the problem in the hairstyling industry, significant amounts of aluminum foil used by hair professionals for various treatments are not recycled, which results in significant amounts being disposed of in landfills, where its robust qualities may make the waste resistant to degradation.

Finally, aluminum foil may be expensive, having traded at upwards of $2000 USD per metric ton on the London Metal Exchange (LME) during the 2014 fiscal year.

Therefore, improvement in the environmental impact of materials used for hairstyling and colouring procedures is desirable.

### SUMMARY

In one aspect, there is provided a sheet comprising: a substantially biodegradable film having a first surface and an opposing second surface; and an adhesive, wherein the adhesive is applied to the first surface and wherein the sheet has a peel force of between about 0.02 pounds per inch to about 0.15 pounds per inch, preferably about 0.03 pounds per inch to about 0.1 pounds per inch, further preferably about 0.07 pounds per inch.

There is also provided in another aspect of the present disclosure a use of the sheet in a cosmetic procedure involving hair.

In a further aspect, there is provided a method for isolating a first bundle of one or more hairs of a subject from a second bundle of one or more hairs of the subject for a cosmetic procedure involving hair, comprising: enveloping the sheet around the first bundle, and adhering the sheet to itself by the first surface to isolate the first bundle from the second bundle.

### DETAILED DESCRIPTION

In one aspect, there is provided a sheet comprising a substantially biodegradable film having a first surface and an opposing second surface; and an adhesive, wherein the adhesive is applied to the first surface and wherein the sheet has a peel force of between about 0.02 pounds per inch to about 0.15 pounds per inch, preferably about 0.03 pounds per inch to about 0.1 pounds per inch, further preferably about 0.07 pounds per inch.

Unless stated otherwise, such as in the examples if so provided, all amounts and numbers used in this specification are intended to be interpreted as modified by the term “about”. Likewise, all materials, compounds or elements identified in this specification, unless stated otherwise, are intended to be non-limiting and representative of other materials, compounds or elements generally considered by those skilled in the art as being within the same family of materials, compounds or elements.

As used herein, the term “biodegradable” means a material that is capable of undergoing partial or complete decomposition into carbon dioxide, methane, water, inorganic compounds, other elements or materials and/or biomass in which a mechanism may, for example and not intended to be limiting, be the enzymatic action of microorganisms, decomposition in water, decomposition by oxidative embrittlement, decomposition by UV embrittlement, or decomposition by another mechanism. As used herein, the term “substantially biodegradable” in reference to a material means that that material is capable of at least 50% decomposition as set forth above, and in increasing preferability, 60%, 70%, 80%, 90% and 100%.

As used herein, the term “adhesive” means any substance that may be applied to a surface of a material that may assist in binding that material to another object, or adherend, and may resist separation from that object. The adhesive, may, for example and not intended to be limiting, be an emulsion or resin, glue, cement, mucilage, or paste, or combinations thereof. The adhesive may, for example, be suitable for application to a film, and may be suitable for securing that object against the film. Adhesives of the present disclosure are preferably removable adhesives, wherein they may be designed to form a temporary bond, and ideally can be removed after a given amount of time without leaving significant residue on the adherend. Removable adhesives may, for example, be designed to repeatedly stick and unstick, and are easily removable. The adhesive is also preferably substantially biodegradable.

A “film” as used herein means one or more thin continuous layers of one or more polymer. In some examples, suitable films include those that are up to 0.5 mm thick, preferably less.

The biodegradable film may have various characteristics, such as thickness or stiffness, which may enable the film to be pliable, particularly enabling bending, folding and refolding of the film, enveloping, wrapping or rolling around objects, for example hair, yet may also allow the film to withstand temporary exposure to the color or bleaching agents commonly used in the cosmetic industry. In addition, the biodegradable film may be required to withstand temperatures that may be applied using a consumer-level or professional hairdryer, for example, temperatures that may be from about 40° C. to about 70° C.

The term “about” as used herein means greater or lesser than the value or range of values stated by 1/10 of the stated values, but is not intended to limit any value or range of values to only this broader definition.

In an embodiment, the biodegradable film is comprised of one layer of a biodegradable polymer.

In an embodiment, the biodegradable film is comprised of at least two layers of a biodegradable polymer.

The biodegradable polymer may be a polythene or polyethylene film that may be modified with an additive to improve degradability and biodegradability, for example, OXO-biodegradable based polymers which may degrade at a predefined rate in the presence of oxygen. These polymers may have a timescale for biodegradation that may be shorter than for conventional polythene or polyethylene polymers in the presence of oxygen. For example, and without being limiting, the biodegradable polymer may alternatively be comprised of naturally-sourced compounds or materials, for example vegetable fats and oils, corn starch, pea starch or microbiota.

In some embodiments, the biodegradable polymer is selected from the group consisting of a polyglycolide (PGA), a polycaprolactone (PCL), a polyvinyl alcohol (PVA), or a polylactic acid (PLA).

In yet other embodiments, the biodegradable polymer is a polylactic acid (PLA).

In some embodiments, the biodegradable polymer is Ingeo™ Biopolymer 4032D.

PLA polymers may be a biodegradable or compostable polymer that may be produced from the condensation polymerization of lactic acid. The monomer used for the production of polylactic acid may be available in two optically active isomers, the D-Lactic acid and the L-lactic acid. The relative amounts of the two isomers when combined together and polymerized may yield various polymers with different crystallinity (amorphous to semicryatalline), crystallization behavior and melting points. Polymers of this type may be available from Cargill-Dow and may be represented by the commercial polymer grades PLA4042™ and PLA4060™. Both resins may be produced by the combination of the two optical isomers of lactic acid, the L-lactic acid and the D-lactic acid in different ratios. The relative ratio of the two isomers may control the final crystallinity and crystallization behavior of the polymers as well as varying physical and thermal properties. Such PLAs may be produced into films by coextrusion and biaxial stretching, which may provide for high clarity and gloss. In some embodiments, the biodegradable polymers comprising the film may, for example, comprise commercially available Ingeo™ Biopolymer 4032D, which, for example, may be purchased in pellet form and converted into a biaxially oriented film with use temperatures up to 300° F. (150° C.).

In some embodiments, the biodegradable film is co-extruded and biaxially oriented. U.S. Pat. No. 7,368,160 (herein incorporated by reference) discloses the manufacture and composition of a co-extruded and biaxially oriented PLA film that is suitable for the described materials and applications.

In an embodiment, the biodegradable film is comprised of a 3-layer EVLON® film.

Biodegradable polymer, for example Ingeo™ Biopolymer 4032D., is available commercially as a 3-layer biodegradable film under the trade name EVLON®, manufactured by Bi-Ax International Inc. EVLON® is comprised of a PLA core, a PLA sealant layer and a PLA treated surface. EVLON® may be industrially composted, and the material may breakdown and revert to carbon dioxide and water in less than 90 days. Further details and characteristics of EVLON®, including various gauges available, may be found in Table 1. A person skilled in the art would understand the variances from the characteristics shown in Tables 1 and 2, that would be permissible, for example, a 10% variance.

TABLE 1
Data sheet for EVLON ®.

| Film | Test | | | | | | | |
|---|---|---|---|---|---|---|---|---|
| Properties | method | Units | Typical Value | | | | | |
| Gauge | BI-AX | Microns | 20 | 25 | 30 | 40 | 75 | 100 |
| | Procedure | Gauge | 78 | 100 | 120 | 160 | 300 | |
| | TWI-7- | | | | | | | |
| | 440 | | | | | | | |
| Yield | BI-AX | M²/Kg | 40.3 | 32.1 | 26.8 | 20.00 | 10.7 | In |
| | Procedure | In²/lb | 28375 | 22700 | 18915 | 14200 | 7566 | Development |
| | TWI-7- | | | | | | | |
| | 440 | | | | | | | |
| Tensile | ASTM | lb/in² | 9000 | 9000 | 9000 | 9000 | 9000 | In |
| Strength | D882 | N/mm² | 62 | 62 | 62 | 62 | 62 | Development |
| MD | | | | | | | | |
| Tensle | ASTM | lb/in² | 14000 | 14000 | 14000 | 14000 | 14000 | |
| Strength TD | D882 | N/mm² | 103 | 103 | 103 | 103 | 103 | |
| Gloss | ASTM | Units | 75 | 75 | 75 | 75 | 75 | In |
| (45° C.) | Standard | | | | | | | Development |
| | D2457 | | | | | | | |
| Haze | ASTM | % | ≤2 | ≤2 | ≤2 | ≤2 | ≤3 | In |
| | Standard | | | | | | | Development |
| | D-1003 | | | | | | | |
| COF | ASTM | tr/metal | 0.5 | 0.5 | 0.5 | 0.5 | 0.5 | In |
| (Target) | D1894 | | | | | | | Development |
| Seal | BI-AX | g/in | 500 | 500 | 500 | 500 | 1000 | In |
| Strength | Procedure | | | | | | | Development |
| | TWI-7- | | | | | | | |
| | 435 | | | | | | | |
| Seal | BI-AX | ° C. | 70 | 70 | 70 | 70 | 80 | In |
| Initiation | Procedure | ° F. | 160 | 160 | 160 | 160 | 185 | Development |
| Temp | TWI-7- | | | | | | | |
| | 435 | | | | | | | |
| MTVR | | g/100 in2/24 hr | 32 | 30 | 24 | 17.5 | 8.0 | In |
| (100° F./38° C., | | g/m2/24 hr | 493 | 465 | 370 | 273 | 138 | Development |
| 100% RH) | | | | | | | | |
| O²TR7 | | cc/100 in2/24 hr | 102 | 78 | 67 | 55 | 26 | In |
| (73° F./23° C., | | cc/m2/24 hr | 1590 | 1210 | 935 | 860 | 410 | Development |
| <0% RH) | | | | | | | | |

In an embodiment, the adhesive is a pressure-sensitive adhesive.

Pressure-sensitive adhesives may be characterized in that they form a bond by the application of light pressure to marry the adhesive with the adherend, for example an object, such as hair. Pressure-sensitive adhesives may be designed with a balance between flow and resistance to flow. Once the adhesive and the adherend are in close proximity, molecular interactions, such as van der Waals forces, may be involved in the bond, contributing to strength of bond.

In some embodiments, the pressure sensitive adhesive comprises a liquid modified synthetic resin emulsion.

In some embodiments, the liquid modified synthetic resin emulsion has a viscosity range of between about 300 cps to about 350 cps at about 24° C. using a Brookfield LV #2 at about 30 rpm. Such a liquid modified synthetic resin emulsion may be purchased Casmar Converting of Hamilton, Ontario, Canada, and Table 2 contains typical properties of a suitable liquid modified synthetic resin emulsion available from Casmar Converting.

TABLE 2
Example of a Suitable Liquid Modified Synthetic Resin Emulsion.

| | |
|---|---|
| PH: | 9-9.5 |
| COLOR: | blue |
| ODOUR: | Very mild |
| VISCOSITY @ 24° C. | 300-350 cps |
| Brookfield LV #2-30 rpm: | |
| SOLIDS: | 24-26% |
| SHELF LIFE: | 6 months/stir before use |
| RUNNING TEMPERATURE: | 15-30° C. |
| FREEZABILITY: | Must be transported and |
| | stored above 15° C. |
| CLEAN UP: | Water |
| Water Resistance: | Moderate |
| FDA compliance | 21CFR 175.105, 21CFR |
| | 176.170, 21CFR 176.180 |

In an embodiment, the biodegradable film has a thickness of about 10 μm to about 400 μm.

In an embodiment, the thickness of the biodegradable film is about 15 μm to about 40 μm.

In an embodiment, the biodegradable film is transparent.

In an embodiment, the biodegradable film is opaque.

In an embodiment, the biodegradable film is coloured.

In an embodiment, the biodegradable film resembles the appearance of a metal foil.

In an embodiment, the sheet has a peel force of about 0.07 pounds per inch.

In some embodiments, the peel force corresponds to a force necessary to peel the sheet off of a second biodegradable film applied to the first surface at an angle of 90 degrees.

In some embodiments, the force is measured by a force gauge that is secured to one of the second surface and the second biodegradable film.

In some embodiments, the force gauge is a Chatillon Force Gauge.

In an embodiment, the biodegradable film has a weight of about 0.0000528 pounds per square inch.

In an embodiment, the adhesive has a coating weight of about 0.0000012 pounds per square inch of the biodegradable film.

In an embodiment, the sheet has a weight of about 0.00054 pounds per square inch.

In an aspect, there is provided a use of the sheet in a cosmetic procedure involving hair.

In an embodiment, the cosmetic procedure is selected from the group consisting of: colouring hair, dyeing hair, highlighting hair and lowlighting hair.

In some embodiments, the hair is human hair.

In some embodiments, the hair is animal hair.

The sheet of the present disclosure may be packaged in rolls of varying widths and lengths, as may be found in consumer-grade aluminum foil products or cellophane, and which may be rolled to the desired length by a user. For example, it is preferable for the sheets to be between 5 cm and 30 cm in width. Independently, it is preferable for the sheets to be between 5 cm and 30 cm in length.

The sheet may be packaged in a container with a cutter for cutting the sheet. The sheet may further be perforated at preferable lengths to facilitate use.

In an aspect, there is provided a use of the sheet of the present disclosure in a cosmetic procedure involving hair.

In use, a user, for example an individual performing a cosmetic procedure on themselves, another individual, or an animal, may cut or otherwise sever the sheet to obtain a length suitable for their specific use or application. However, rolls of the sheet of the present disclosure may be pre-scored or pre-cut at specific lengths to yield pre-sized sheets of the composition at consistent or alternating lengths. The sheets of the present disclosure may also be packaged as precut individual segments of square, rectangular or other shapes in one or more sizes, which may enable convenient ease of use for the user.

In a further aspect of the present disclosure, there is provided a method for isolating a first bundle of one or more hairs of a subject from a second bundle of one or more hairs of the subject for a cosmetic procedure involving hair, comprising enveloping the sheet of any one of claims 1 to 24 around the first bundle; and adhering the sheet to itself by the first surface to isolate the first bundle from the second bundle.

In some embodiments, the method further comprises removing the sheet from the first bundle after completion of the cosmetic procedure.

Compositions of the present disclosure may be manufactured, produced or otherwise created using the materials, tools, methods and processes known to those skilled in the art, and which are not repeated herein. The various elements of the sheet, for example the biodegradable film and the adhesive, may, for example, be produced individually and combined thereafter, or produced simultaneously, in a single or multi-step manufacturing process. For various embodiments of the present disclosure, the financial cost of manufacturing said composition may be comparable to that of aluminum or other metal foils.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

1. A sheet comprising:
a substantially biodegradable film having a first surface and an opposing second surface; and
an adhesive, wherein the adhesive is applied to the first surface;
and wherein the sheet has a peel force of between about 0.02 pounds per inch to about 0.15 pounds per inch, preferably about 0.03 pounds per inch to about 0.1 pounds per inch, further preferably about 0.07 pounds per inch.

2. The sheet of claim 1, wherein the biodegradable film is comprised of one layer of a biodegradable polymer.

3. The sheet of claim 1, wherein the biodegradable film is comprised of at least two layers of a biodegradable polymer.

4. The sheet of claim 2, wherein the biodegradable polymer is selected from the group consisting of a polyglycolide (PGA), a polycaprolactone (PCL), a polyvinyl alcohol (PVA), or a polylactic acid (PLA).

5. The sheet of claim 2, wherein the biodegradable polymer is a polylactic acid (PLA).

6. The sheet of claim 5, wherein the biodegradable polymer is Ingeo™ Biopolymer 4032D.

7. The sheet of claim 3, wherein the biodegradable film is co-extruded and biaxially oriented.

8. The sheet of claim 1, wherein the biodegradable film is comprised of a 3-layer EVLON® film.

9. The sheet of claim 1, wherein the adhesive is a pressure sensitive adhesive.

10. The sheet of claim 9, wherein the pressure sensitive adhesive comprises a liquid modified synthetic resin emulsion.

11. The sheet of claim 10, wherein the liquid modified synthetic resin emulsion has a viscosity range of between about 300 to about 350 cps at about 24° C. using a Brookfield LV #2 at about 30 rpm.

12. The sheet of claim 1, wherein the biodegradable film has a thickness of about 10 μm to about 400 μm.

13. The sheet of claim 12, wherein the thickness is about 15 μm to about 40 μm.

14. The sheet of claim 1, wherein the biodegradable film is transparent.

15. The sheet of claim 1, wherein the biodegradable film is opaque.

16. The sheet of claim 1, wherein the biodegradable film is coloured.

17. The sheet of claim 1, wherein the biodegradable film resembles the appearance of a metal foil.

18. The sheet of claim 1, wherein the sheet has a peel force of about 0.07 pounds per inch.

19. The sheet of claim 1, wherein the peel force corresponds to a force necessary to peel the sheet off of a second biodegradable film applied to the first surface at an angle of 90 degrees.

20. The sheet of claim 19, wherein the force is measured by a force gauge that is secured to one of the second surface and the second biodegradable film.

21. The sheet of claim 20, wherein the force gauge is a Chatillon Force Gauge.

22. The sheet of claim 1, wherein the biodegradable film has a weight of about 0.0000528 pounds per square inch.

23. The sheet of claim 1, wherein the adhesive has a coating weight of about 0.0000012 pounds per square inch of the biodegradable film.

24. The sheet of claim 1, wherein the sheet has a weight of about 0.00054 pounds per square inch.

25. (canceled)

26. (canceled)

27. (canceled)

28. (canceled)

29. A method for isolating a first bundle of one or more hairs of a subject from a second bundle of one or more hairs of the subject for a cosmetic procedure involving hair, comprising:
enveloping the sheet of around the first bundle; and
adhering the sheet to itself by the first surface to isolate the first bundle from the second bundle.

30. The method of claim 29, wherein the cosmetic procedure is selected from the group consisting of: colouring, dyeing, highlighting and lowlighting.

31. The method of claim 30, further comprising removing the sheet from the first bundle after completion of the cosmetic procedure.
